(19) United States
(12) Patent Application Publication
(10) Pub. No.: US 2017/0195626 A1
(43) Pub. Date: Jul. 6, 2017

(54) METHOD FOR SMART TELEVISION AUDIO AND VIDEO COMMUNICATION

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Yonggui ZHAO, Tianjin (CN)

(21) Appl. No.: 15/250,558

(22) Filed: Aug. 29, 2016

Related U.S. Application Data
(63) Continuation of application No. PCT/CN2016/088724, filed on Jul. 5, 2016.

(30) Foreign Application Priority Data
Dec. 30, 2015 (CN) 201511031477.7

(51) Int. Cl. H04N 7/14; H04N 21/4788; H04N 21/61; H04N 21/4363; H04L 29/06; H04N 7/15

(52) U.S. Cl. CPC H04N 7/147; H04L 65/1069; H04N 7/15; H04N 21/6125; H04N 21/43637; H04N 21/4788; H04W 88/04

(57) ABSTRACT

A method, a terminal device and a smart television for smart television audio and video communication is disclosed. The method includes: receiving, by a second mobile terminal, a call request message sent by a first mobile terminal for requesting to establish audio and video communication between the first mobile terminal and the second mobile terminal, wherein the second mobile terminal is communicably connected to the smart television; determining, by the second mobile terminal, to conduct the audio and video communication via the smart television; and replying, by the second mobile terminal, to the call request message, such that the audio and video communication is conducted between the first mobile terminal and the smart television. In the technical solutions according to the embodiments of the present disclosure, the large screen of the television and high definition thereof are fully utilized, and since the old are familiar with operations of the television, the technical solution according to the embodiment of the present disclosure is suitable for the old at home, and the operations are convenient and simple.

### CROSS-REFERENCE TO RELATED APPLICATIONS

This application is a continuation of International Application No. PCT/CN2016/088724 filed on Jul. 5, 2016, which is based upon and claims priority to Chinese Patent Application No. 201511031477.7, filed before Chinese Patent Office on Dec. 30, 2015 and entitled “METHOD FOR SMART TELEVISION AUDIO AND VIDEO COMMUNICATION”, the entire contents of which are incorporated herein by reference.

### TECHNICAL FIELD

The present disclosure relates to the technical field of video communication, and more particularly, to a method for smart television audio and video communication and a terminal device thereof.

### BACKGROUND

With the dramatic development of communications technologies, video communication becomes a basic demand for long-distance communication among people. Nowadays, video communication is gradually being accepted and widely used in daily life. Mobile phones and televisions are indispensable in modern life. In any region which is serviced by the network, the mobile phones may help people to achieve communication therebetween anytime. In addition, with the advancement of the communication technologies, video call via mobile terminals becomes a powerful function of the mobile phones.

During implementation of the present disclosure, the inventors have identified that the related art has at least the following problem: in a conventional video call system, a mobile phone-to-mobile phone video call is generally employed, and no system is available for video calls between a television and a mobile phone. As such, with respect to the old not accustomed to using the mobile phone, video calls with their families may not be achieved. Especially, in today's society, the working places of most people are far away from the dwelling places of their old at home, and they may not accompany with the old. Although they may call their old at home or may conduct video calls with their old, the screen of the mobile phone is small and the mobile phone needs to be constantly held during the call, and the old generally have poor eyesight. If video calls with their sons or daughters by using the computer over the network are complicated and troublesome, many old people are reluctant. However, televisions are commonly used by most of the old, the screen of the televisions becomes larger and larger with the technology advancement, and the image displayed is clearer and clearer.

In view of the above, embodiments of the present disclosure are intended to provide a method for smart television audio and video communication, and a terminal device and a smart television thereof, which are suitable for the old at home, fully utilize the large screen of the television and high definition thereof for the audio and video calls, and the operations are convenient and simple.

### SUMMARY

The present disclosure provides a method for smart television audio and video communication, and a mobile terminal and a smart television thereof, which may solve the technical problem that image display is not clear during audio and video calls and operations are not convenient in the related art.

Embodiments of the present disclosure provide a method for smart television audio and video communication. The method is applied to a smart television, and includes:

receiving, by a second mobile terminal, a call request message sent by a first mobile terminal for requesting to establish audio and video communication between the first mobile terminal and the second mobile terminal, wherein the second mobile terminal is communicably connected to the smart television;

determining, by the second mobile terminal, to conduct the audio and video communication via the smart television; and

replying, by the second mobile terminal, to the call request message, such that the audio and video communication is conducted between the first mobile terminal and the smart television.

A method for smart television audio and video communication is provided. The method is applied to a smart television, and includes:

establishing a communication connection between the smart television and a second mobile terminal;

detecting, by the smart television, that the second mobile terminal receives a call request message, wherein the call request message is sent by a first mobile terminal and used for requesting to establish audio and video communication between the first mobile terminal and the second mobile terminal;

detecting, by the smart television, that the second mobile terminal determines to conduct the audio and video communication with the first mobile terminal via the smart television;

detecting, by the smart television, that the second mobile terminal sends a response message to the call request message, wherein the response message is sent by the second mobile terminal to the first mobile terminal; and

conducting, by the smart television, the audio and video communication with the first mobile terminal.

A method for smart television audio and video communication is provided. The method is applied to a smart television, and includes:

sending, by a first mobile terminal, a call request message to a second mobile terminal for requesting to establish audio and video communication between the first mobile terminal and the second mobile terminal, wherein the first mobile terminal is communicably connected to the smart television;

determining, by the first mobile terminal, to conduct the audio and video communication via the smart television; and

receiving, by the first mobile terminal, a response message to the call request message sent by the second mobile terminal, such that the audio and video communication is conducted between the smart television and the second mobile terminal.

A method for smart television audio and video communication is provided. The method is applied to a smart television, and includes:

establishing a communication connection between the smart television and a first mobile terminal;

detecting, by the smart television, that the first mobile terminal sends a call request message, wherein the call request message is used for requesting to establish audio and video communication between the first mobile terminal and the second mobile terminal;

detecting, by the smart television, that the first mobile terminal determines to conduct the audio and video communication with the second mobile terminal via the smart television;

detecting, by the smart television, that the first mobile terminal receives a response message to the call request message, wherein the response message is sent by the second mobile terminal; and

conducting, by the smart television, the audio and video communication with the second mobile terminal.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a method for smart television communication according to some embodiments of the present disclosure;

FIG. 2 is a schematic flowchart illustrating a method for smart television communication according to some embodiments of the present disclosure;

FIG. 3 is a schematic flowchart illustrating a method for smart television communication according to some embodiments of the present disclosure;

FIG. 4 is a schematic flowchart illustrating a method for smart television communication according to some embodiments of the present disclosure;

FIG. 5 is a schematic flowchart illustrating a method for smart television communication according to some embodiments of the present disclosure;

FIG. 6 is a schematic flowchart illustrating a method for smart television communication according to some embodiments of the present disclosure;

FIG. 7 is a schematic structural diagram illustrating a second mobile terminal according to some embodiments the present disclosure;

FIG. 8 is a schematic structural diagram illustrating a first mobile terminal according to some embodiments the present disclosure;

FIG. 9 is a schematic structural diagram of a smart television according to some embodiments of the present disclosure;

FIG. 10 is a schematic structural diagram of a smart television according to some embodiments of the present disclosure;

FIG. 11 is a schematic structural diagram of a system for smart television communication according to some embodiments of the present disclosure; and

FIG. 12 is a schematic structural diagram of a system for smart television communication according to some embodiments of the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

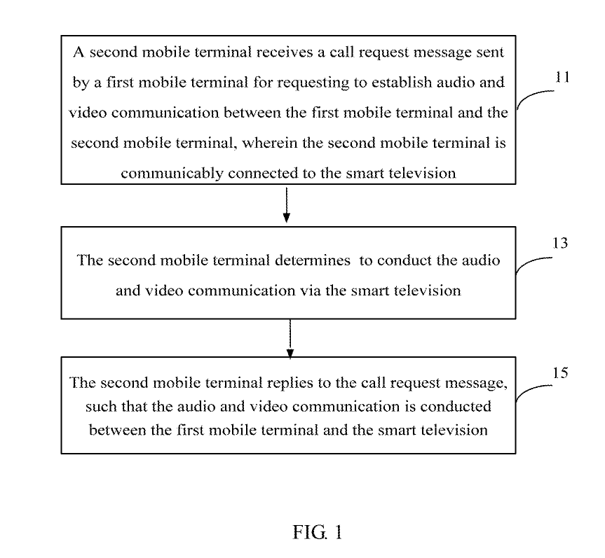

Referring to FIG. 1, a schematic flowchart illustrating a method for smart television communication according to some embodiments of the present disclosure is illustrated. The method for smart television audio and video communication according to this embodiment of the present disclosure includes the following steps:

Step 11: A second mobile terminal receives a call request message sent by a first mobile terminal for requesting to establish audio and video communication between the first mobile terminal and the second mobile terminal, wherein the second mobile terminal is communicably connected to the smart television.

Step 13: The second mobile terminal determines to conduct the audio and video communication via the smart television.

Step 15: replying, by the second mobile terminal, to the call request message, such that the audio and video communication is conducted between the first mobile terminal and the smart television.

In the technical solution of the method for audio and video communication according to the embodiment of the present disclosure, when the audio and video communication is conducted, the second mobile terminal, as the calling party, to which the smart television is connected may be prompted to determine whether to select the smart television to conduct the audio and video communication, and when the second mobile terminal determines to conduct the audio and video communication via the smart television, the audio and video communication is conducted between the smart television and the first mobile terminal. In this case, the audio and video information of the calling party may be displayed on the smart television, and the image is clear. In the technical solution according to the embodiment of the present disclosure, the large screen of the television and high definition thereof are fully utilized for the audio and video calls, and since the old are familiar with operations of the television, the technical solution according to the embodiment of the present disclosure is suitable for the old at home, and the operations are convenient and simple.

Further, in the technical solution according to the embodiment of the present disclosure, that the second mobile terminal is communicably connected to the smart television specifically includes: establishing a communication connection between the second mobile terminal and the smart television via WiFi, USB or Bluetooth.

Further, in the technical solution according to the embodiment of the present disclosure, the replying, by the second mobile terminal, to the call request message, such that the audio and video communication is conducted between the first mobile terminal and the smart television specifically includes: replying, by the second mobile terminal, to the call request message, such that communication is established between the first mobile terminal and the smart television, video information of the first mobile terminal is displayed on the smart television and audio signals of the first mobile terminal are played on the smart television, and audio signals of the second mobile terminal are transmitted to the first mobile terminal via the second mobile terminal. The second mobile terminal determines to conduct the audio and video communication with the first mobile terminal via the smart television, the audios and videos sent by the calling party, i.e., the first mobile terminal, may be displayed on the smart television, the audios of the called party, i.e., the second mobile terminal, may be transmitted to the first mobile terminal via the second mobile terminal, and the videos of the called party, i.e., the second mobile terminal, may be displayed on the first mobile terminal. Nevertheless, the videos of the called party, i.e., the second mobile terminal, may be transmitted to the first mobile terminal via the smart television, or may be transmitted to the first mobile terminal via the second mobile terminal.

Further, in the technical solution according to the embodiment of the present disclosure, the replying, by the second mobile terminal, to the call request message, such that the audio and video communication is conducted between the first mobile terminal and the smart television specifically includes: replying, by the second mobile terminal, to the call request message, such that communication is established between the first mobile terminal and the smart television, video information of the first mobile terminal is displayed on the smart television and audio signals of the first mobile terminal are played on the smart television, and audio signals of the second mobile terminal are transmitted to the first mobile terminal via the smart television. The second mobile terminal determines to conduct the audio and video communication with the first mobile terminal via the smart television, the audios and videos sent by the calling party, i.e., the first mobile terminal, may be displayed on the smart television, the audios of the called party, i.e., the second mobile terminal, may be transmitted to the first mobile terminal via the smart television, and the videos of the called party, i.e., the second mobile terminal, may be displayed on the first mobile terminal. Nevertheless, the videos of the called party, i.e., the second mobile terminal, may be transmitted to the first mobile terminal via the smart television, or may be transmitted to the first mobile terminal via the second mobile terminal.

Further, in the technical solution according to the embodiment of the present disclosure, the determining, by the second mobile terminal, to conduct the audio and video communication via the smart television includes: displaying, by the second mobile terminal, prompt information indicating whether the audio and video communication is conducted via the smart television; and when the prompt information indicates that the audio and video communication is conducted via the smart television, determining, by the second mobile terminal, to conduct the audio and video communication via the smart television. When the user of the called party, i.e., the second mobile terminal, determines, according to the prompt information, to conduct the audio and video communication via the smart television, it indicates that the second mobile terminal determines to conduct the audio and video communication via the smart television.

The present disclosure further provides a computer readable storage medium which stores a program configured to perform the above method.

The computer readable storage medium includes any mechanism for storing or transferring information in a computer readable form (for example, a personal computer). For example, the machine readable medium includes a read-only memory (ROM), a random access memory (RAM), a disk storage medium, an optical storage medium, a flash storage medium, electricity, light, sound and other forms of propagation signals (for example, a carrier, an infrared signal, a digital signal and the like), and the like.

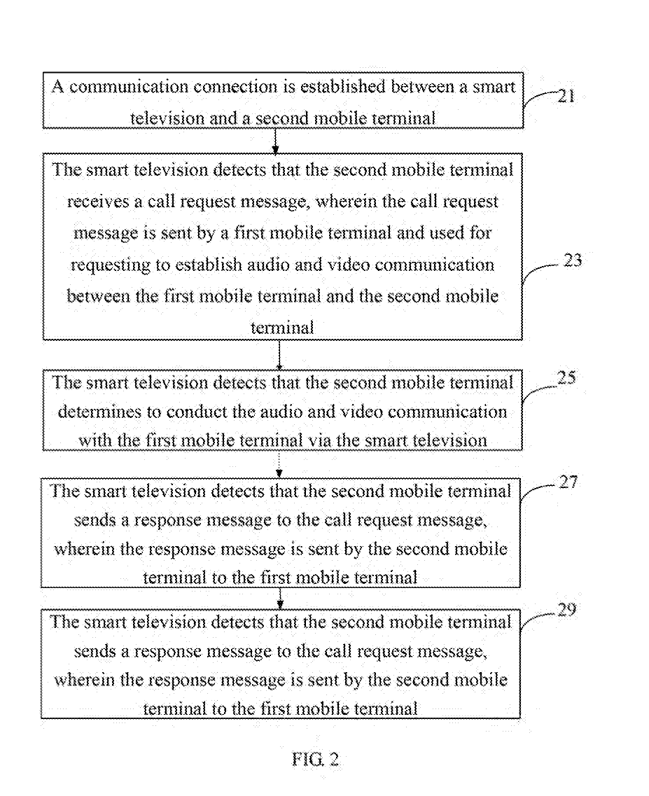

Referring to FIG. 2, a schematic flowchart illustrating a method for smart television communication according to some embodiments of the present disclosure is illustrated. The method for smart television audio and video communication according to this embodiment of the present disclosure includes the following steps:

Step 21: A communication connection is established between a smart television and a second mobile terminal.

Step 23: The smart television detects that the second mobile terminal receives a call request message, wherein the call request message is sent by a first mobile terminal and used for requesting to establish audio and video communication between the first mobile terminal and the second mobile terminal.

Step 25: The smart television detects that the second mobile terminal determines to conduct the audio and video communication with the first mobile terminal via the smart television.

Step 27: The smart television detects that the second mobile terminal sends a response message to the call request message, wherein the response message is sent by the second mobile terminal to the first mobile terminal.

Step 29: The smart television conducts the audio and video communication with the first mobile terminal.

In the technical solution of the method for audio and video communication according to the embodiment of the present disclosure, when the audio and video communication is conducted, the second mobile terminal, as the calling party, to which the smart television is connected may be prompted to determine whether to select the smart television to conduct the audio and video communication, and when the second mobile terminal determines to conduct the audio and video communication via the smart television, the audio and video communication is conducted between the smart television and the first mobile terminal. In this case, the audio and video information sent by the calling party, i.e., the first mobile terminal, may be displayed on the smart television, and the image is clear. In the technical solution according to the embodiment of the present disclosure, the large screen of the television and high definition thereof are fully utilized for the audio and video calls, and since the old are familiar with operations of the television, the technical solution according to the embodiment of the present disclosure is suitable for the old at home, and the operations are convenient and simple.

Further, in the technical solution according to the embodiment of the present disclosure, that the second mobile terminal is communicably connected to the smart television specifically includes: establishing a communication connection between the second mobile terminal and the smart television via WiFi. USB or Bluetooth.

Further, in the technical solution according to the embodiment of the present disclosure, the conducting, by the smart television, the audio and video communication with the first mobile terminal includes: displaying video information of the first mobile terminal on the smart television and playing audio signals of the first mobile terminal on the smart television, and transmitting audio signals of the second mobile terminal to the first mobile terminal via the second mobile terminal. The second mobile terminal determines to conduct the audio and video communication with the first mobile terminal via the smart television, the audios and videos sent by the calling party, i.e., the first mobile terminal, may be displayed on the smart television, the audios of the called party, i.e., the second mobile terminal, may be transmitted to the first mobile terminal via the second mobile terminal, and the videos of the called party, i.e., the second mobile terminal, may be displayed on the first mobile terminal. Nevertheless, the videos of the called party, i.e., the second mobile terminal, may be transmitted to the first mobile terminal via the smart television, or may be transmitted to the first mobile terminal via the second mobile terminal.

Further, in the technical solution according to the embodiment of the present disclosure, the conducting, by the smart television, the audio and video communication with the second mobile terminal includes: displaying video information of the first mobile terminal on the smart television and playing audio signals of the first mobile terminal on the smart television, and transmitting audio signals of the second mobile terminal to the first mobile terminal via the smart television. The second mobile terminal determines to conduct the audio and video communication with the first mobile terminal via the smart television, the audios and videos sent by the calling party, i.e., the first mobile terminal, may be displayed on the smart television, the audios of the called party, i.e., the second mobile terminal, may be transmitted to the first mobile terminal via the smart television, and the videos of the called party, i.e., the second mobile terminal, may be displayed on the first mobile terminal. Nevertheless, the videos of the called party, i.e., the second mobile terminal, may be transmitted to the first mobile terminal via the smart television, or may be transmitted to the first mobile terminal via the second mobile terminal.

Further, in the technical solution of the embodiment of the present disclosure, the detecting, by the smart television, that the first mobile terminal determines to conduct the audio and video communication with the second mobile terminal via the smart television includes: displaying, by the smart television, prompt information indicating whether the audio and video communication is conducted via the smart television, and when the prompt information indicates that the audio and video communication is conducted via the smart television, determining, by the second mobile terminal, to conduct the audio and video communication via the smart television. When the user of the called party, i.e., the second mobile terminal, determines, according to the prompt information, to conduct the audio and video communication via the smart television, it indicates that the second mobile terminal determines to conduct the audio and video communication via the smart television.

The present disclosure further provides a computer readable storage medium which stores a program configured to perform the above method.

The computer readable storage medium includes any mechanism for storing or transferring information in a computer readable form (for example, a personal computer). For example, the machine readable medium includes a read-only memory (ROM), a random access memory (RAM), a disk storage medium, an optical storage medium, a flash storage medium, electricity, light, sound and other forms of propagation signals (for example, a carrier, an infrared signal, a digital signal and the like), and the like.

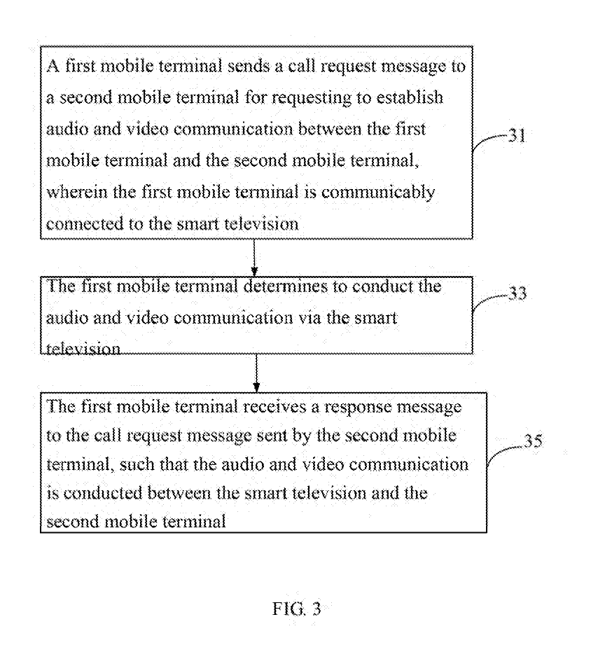

Referring to FIG. 3, a schematic flowchart illustrating a method for smart television communication according to some embodiments of the present disclosure is illustrated. The method for smart television audio and video communication according to this embodiment of the present disclosure includes the following steps:

Step 31: A first mobile terminal sends a call request message to a second mobile terminal for requesting to establish audio and video communication between the first mobile terminal and the second mobile terminal, wherein the first mobile terminal is communicably connected to the smart television.

Step 33: The first mobile terminal determines to conduct the audio and video communication via the smart television.

Step 35: The first mobile terminal receives a response message to the call request message sent by the second mobile terminal, such that the audio and video communication is conducted between the smart television and the second mobile terminal.

In the technical solution of the method for audio and video communication according to the embodiment of the present disclosure, when the audio and video communication is conducted, the first mobile terminal, as the calling party, to which the smart television is connected may be prompted to determine whether to select the smart television to conduct the audio and video communication, and when the first mobile terminal determines to conduct the audio and video communication via the smart television, the audio and video communication is conducted between the smart television and the second mobile terminal. In this case, the audio and video information sent by the called party, i.e., the second mobile terminal, may be displayed on the smart television. In the technical solution according to the embodiment of the present disclosure, the large screen of the television and high definition thereof are fully utilized for the audio and video calls. Since the old are familiar with operations of the television, the technical solution according to the embodiment of the present disclosure is suitable for the old at home, and the operations are convenient and simple.

Further, in the technical solution according to the embodiment of the present disclosure, that the second mobile terminal is communicably connected to the smart television specifically includes: establishing a communication connection between the second mobile terminal and the smart television via WiFi, USB or Bluetooth.

Further, in the technical solution according to the embodiment of the present disclosure, the receiving, by the first mobile terminal, a response message to the call request message sent by the second mobile terminal, such that the audio and video communication is conducted between the smart television and the second mobile terminal includes: receiving, by the first mobile terminal, a response message to the call request message sent by the second mobile terminal, such that communication is established between the smart television and the second mobile terminal, video information of the second mobile terminal is displayed on the smart television and audio signals of the second mobile terminal are played on the smart television, and audio signals of the first mobile terminal are transmitted to the second mobile terminal via the first mobile terminal. The first mobile terminal determines to conduct the audio and video communication with the first mobile terminal via the smart television, the audios and videos sent by the called party, i.e., the second mobile terminal, may be displayed on the smart television, the audios of the calling party, i.e., the first mobile terminal, may be transmitted to the second mobile terminal via the first mobile terminal, and the videos of the calling party, i.e., the first mobile terminal, may be displayed on the second mobile terminal. Nevertheless, the videos of the calling party, i.e., the first mobile terminal, may be transmitted to the second mobile terminal via the smart television, or may be transmitted to the second mobile terminal via the first mobile terminal.

Further, in the technical solution according to the embodiment of the present disclosure, the receiving, by the first mobile terminal, a response message to the call request message sent by the second mobile terminal, such that the audio and video communication is conducted between the smart television and the second mobile terminal includes: receiving, by the first mobile terminal, a response message to the call request message sent by the second mobile terminal, such that communication is established between the smart television and the second mobile terminal, video information of the second mobile terminal is displayed on the smart television and audio signals of the second mobile terminal are played on the smart television, and audio signals of the first mobile terminal are transmitted to the second mobile terminal via the smart television. The second mobile terminal determines to conduct the audio and video communication with the first mobile terminal via the smart television, the audios and videos sent by the called party, i.e., the second mobile terminal, may be displayed on the smart television, the audios of the calling party, i.e., the first mobile terminal, may be transmitted to the second mobile terminal via the first mobile terminal, and the videos of the calling party, i.e., the first mobile terminal, may be displayed on the second mobile terminal. Nevertheless, the videos of the calling party, i.e., the first mobile terminal, may be transmitted to the second mobile terminal via the smart television, or may be transmitted to the second mobile terminal via the first mobile terminal.

Further, in the technical solution according to the embodiments of the present disclosure, the determining, by the first mobile terminal, to conduct the audio and video communication via the smart television includes: displaying, by the first mobile terminal, prompt information indicating whether the audio and video communication is conducted via the smart television; and when the prompt information indicates that the audio and video communication is conducted via the smart television, determining, by the first mobile terminal, to conduct the audio and video communication via the smart television. When the user of the calling party, i.e., the first mobile terminal, determines, according to the prompt information, to conduct the audio and video communication via the smart television, it indicates that the first mobile terminal determines to conduct the audio and video communication via the smart television.

The present disclosure further provides a computer readable storage medium which stores a program configured to perform the above method.

The computer readable storage medium includes any mechanism for storing or transferring information in a computer readable form (for example, a personal computer). For example, the machine readable medium includes a read-only memory (ROM), a random access memory (RAM), a disk storage medium, an optical storage medium, a flash storage medium, electricity, light, sound and other forms of propagation signals (for example, a carrier, an infrared signal, a digital signal and the like), and the like.

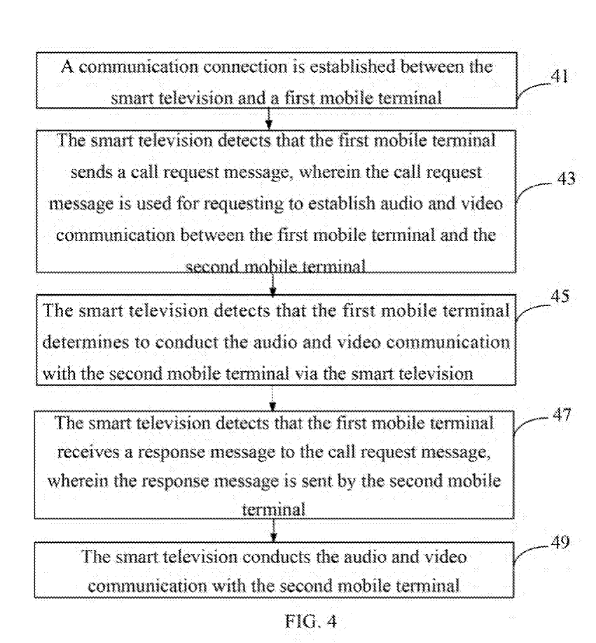

Referring to FIG. 4, a schematic flowchart illustrating a method for smart television communication according to some embodiments of the present disclosure is illustrated. The method for smart television audio and video communication according to this embodiment of the present disclosure includes the following steps;

Step 41: A communication connection is established between the smart television and a first mobile terminal.

Step 43: The smart television detects that the first mobile terminal sends a call request message, wherein the call request message is used for requesting to establish audio and video communication between the first mobile terminal and the second mobile terminal.

Step 45: The smart television detects that the first mobile terminal determines to conduct the audio and video communication with the second mobile terminal via the smart television.

Step 47: The smart television detects that the first mobile terminal receives a response message to the call request message, wherein the response message is sent by the 20 second mobile terminal.

Step 49: The smart television conducts the audio and video communication with the second mobile terminal.

In the technical solution of the method for audio and video communication according to the embodiment of the present disclosure, when the audio and video communication is conducted, the first mobile terminal, as the calling party, to which the smart television is connected may be prompted to determine whether to select the smart television to conduct the audio and video communication, and when the first mobile terminal determines to conduct the audio and video communication via the smart television, the audio and video communication is conducted between the smart television and the second mobile terminal. In this case, the audio and video information sent by the called party, i.e., the second mobile terminal, may be displayed on the smart television. In the technical solution according to the embodiment of the present disclosure, the large screen of the television and high definition thereof are fully utilized for the audio and video calls, and the image is clear. Since the old are familiar with operations of the television, the technical solution according to the embodiment of the present disclosure is suitable for the old at home, and the operations are convenient and simple.

Further, in the technical solution according to the embodiment of the present disclosure, that the first mobile terminal is communicably connected to the smart television specifically includes: establishing a communication connection between the first mobile terminal and the smart television via WiFi, USB or Bluetooth.

Further, in the technical solution according to the embodiment of the present disclosure, the conducting, by the smart television, the audio and video communication with the second mobile terminal includes: displaying video information of the second mobile terminal on the smart television and playing audio signals of the second mobile terminal on the smart television, and transmitting audio signals of the first mobile terminal to the second mobile terminal via the first mobile terminal. The first mobile terminal determines to conduct the audio and video communication with the first mobile terminal via the smart television, the audios and videos sent by the called party, i.e., the second mobile terminal, may be displayed on the smart television, the audios of the calling party, i.e., the first mobile terminal, may be transmitted to the second mobile terminal via the first mobile terminal, and the videos of the calling party, i.e., the first mobile terminal, may be displayed on the second mobile terminal. Nevertheless, the videos of the calling party, i.e., the first mobile terminal, may be transmitted to the second mobile terminal via the smart television, or may be transmitted to the second mobile terminal via the first mobile terminal.

Further, in the technical solution according to the embodiment of the present disclosure, the conducting, by the smart television, the audio and video communication with the second mobile terminal includes: displaying video information of the second mobile terminal on the smart television and playing audio signals of the second mobile terminal on the smart television, and transmitting audio signals of the first mobile terminal to the second mobile terminal via the smart television. The second mobile terminal determines to conduct the audio and video communication with the first mobile terminal via the smart television, the audios and videos sent by the called party, i.e., the second mobile terminal, may be displayed on the smart television, the audios of the calling party, i.e., the first mobile terminal, may be transmitted to the second mobile terminal via the first mobile terminal, and the videos of the calling party, i.e., the first mobile terminal, may be displayed on the second mobile terminal. Nevertheless, the videos of the calling party, i.e., the first mobile terminal, may be transmitted to the second mobile terminal via the smart television, or may be transmitted to the second mobile terminal via the first mobile terminal.

Further, in the technical solution of the embodiment of the present disclosure, the detecting, by the smart television, that the first mobile terminal determines to conduct the audio and video communication with the second mobile terminal via the smart television includes: displaying, by the smart television, prompt information indicating whether the audio and video communication is conducted via the smart television, and when the prompt information indicates that the audio and video communication is conducted via the smart television, determining, by the first mobile terminal, to conduct the audio and video communication via the smart television. When the user of the calling party, i.e., the first mobile terminal, determines, according to the prompt information, to conduct the audio and video communication via the smart television, it indicates that the first mobile terminal determines to conduct the audio and video communication via the smart television.

The present disclosure further provides a computer readable storage medium which stores a program configured to perform the above method.

The computer readable storage medium includes any mechanism for storing or transferring information in a computer readable form (for example, a personal computer). For example, the machine readable medium includes a read-only memory (ROM), a random access memory (RAM), a disk storage medium, an optical storage medium, a flash storage medium, electricity, light, sound and other forms of propagation signals (for example, a carrier, an infrared signal, a digital signal and the like), and the like.

Referring to FIG. 5, a schematic flowchart illustrating a method for smart television communication according to some embodiments of the present disclosure is illustrated. The method for smart television audio and video communication according to this embodiment of the present disclosure includes the following steps:

Step 51: A first mobile terminal sends a call request message to a second mobile terminal for requesting to establish audio and video communication between the first mobile terminal and the second mobile terminal, wherein the first mobile terminal is communicably connected to the smart television;

Step 53: The first mobile terminal determines to conduct the audio and video communication via the smart television.

Step 55: The second mobile terminal sends a response message to the call request message to the first mobile terminal.

Step 57: The smart television conducts the audio and video communication with the second mobile terminal.

In the technical solution of the method for audio and video communication according to the embodiment of the present disclosure, when the audio and video communication is conducted, the first mobile terminal, as the calling party, to which the smart television is connected may be prompted to determine whether to select the smart television to conduct the audio and video communication, and when the first mobile terminal determines to conduct the audio and video communication via the smart television, the audio and video communication is conducted between the smart television and the second mobile terminal. In this case, the audio and video information sent by the called party, i.e., the second mobile terminal, may be displayed on the smart television. In the technical solution according to the embodiment of the present disclosure, the large screen of the television and high definition thereof are fully utilized for the audio and video calls, and the image is clear. Since the old are familiar with operations of the television, the technical solution according to the embodiment of the present disclosure is suitable for the old at home, and the operations are convenient and simple.

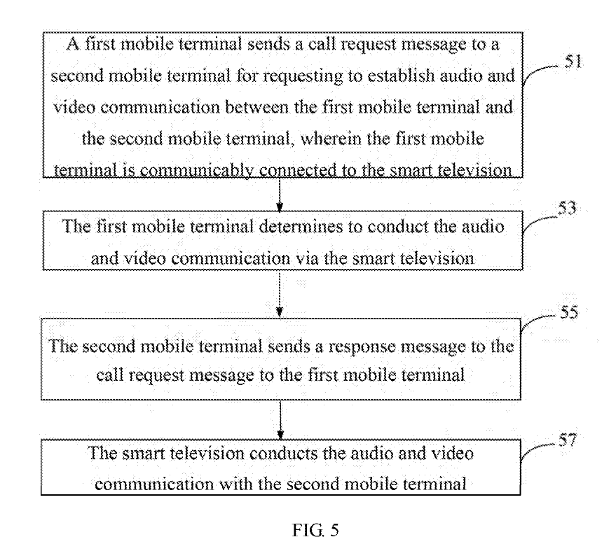

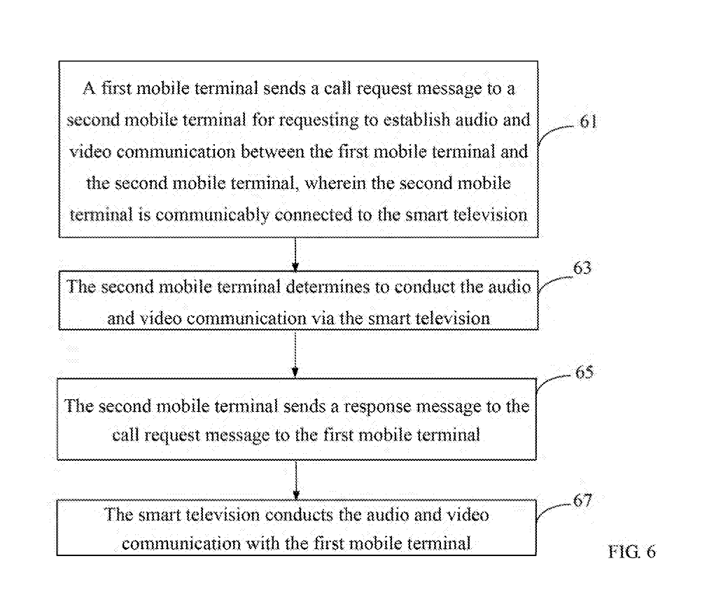

Referring to FIG. 6, a schematic flowchart illustrating a method for smart television communication according to some embodiments of the present disclosure is illustrated. The method for smart television audio and video communication according to this embodiment of the present disclosure includes the following steps:

Step 61: A first mobile terminal sends a call request message to a second mobile terminal for requesting to establish audio and video communication between the first mobile terminal and the second mobile terminal, wherein the second mobile terminal is communicably connected to the smart television;

Step 63: The second mobile terminal determines to conduct the audio and video communication via the smart television.

Step 65: The second mobile terminal sends a response message to the call request message to the first mobile terminal.

Step 67: The smart television conducts the audio and video communication with the first mobile terminal.

In the technical solution of the method for audio and video communication according to the embodiment of the present disclosure, when the audio and video communication is conducted, the called second mobile terminal to which the smart television is connected may be prompted to determine whether to select the smart television to conduct the audio and video communication, and when the second mobile terminal determines to conduct the audio and video communication via the smart television, the audio and video communication is conducted between the smart television and the first mobile terminal. In this case, the audio and video information of the calling party may displayed on the smart television, and the image is clear. In the technical solution according to the embodiment of the present disclosure, the large screen of the television and high definition thereof are fully utilized for the audio and video calls, and since the old are familiar with operations of the television, the technical solution according to the embodiment of the present disclosure is suitable for the old at home, and the operations are convenient and simple.

In the technical solution according to the embodiment illustrating the method for smart television communication according to the present disclosure, in the present disclosure, the calling party and the called party may be each communicably connected to a smart television, that is, the first mobile terminal and the second mobile terminal in various embodiments are each communicably connected to a smart television, and during the audio and video communication, both the calling party and the called party may determine to conduct the audio and video communication via the connected smart television. The audios and videos sent by the calling party may be displayed on the smart television connected to the calling party, i.e., the second mobile terminal, and the audios and videos sent by the called party may be displayed on the smart television connected to the calling party, i.e., the first mobile terminal. The audios of the calling party may be transmitted to the called party via the first mobile terminal or the smart television connected to the first mobile terminal, and the videos of the calling party may be transmitted to the called party via the first mobile terminal or the smart television connected to the first mobile terminal. The audios of the called party may be transmitted to the calling party via the second mobile terminal or the smart television connected to the second mobile terminal, and the videos of the called party may be transmitted to the calling party via the second mobile terminal or the smart television connected to the second mobile terminal.

In various technical solutions according to the embodiments illustrating the methods for smart television communication according to the present disclosure, when determining whether to conduct the audio and video communication via the smart television, the prompt information may be displayed on both the first mobile terminal and the smart television connected to the first mobile terminal or both the second mobile terminal and the smart television connected to the second mobile terminal, or the prompt information may be displayed only on the first mobile terminal or the smart television connected to the first mobile terminal, or the second mobile terminal or the smart television connected to the second mobile terminal.

The present disclosure further provides a computer readable storage medium which stores a program configured to perform the above method.

The computer readable storage medium includes any mechanism for storing or transferring information in a computer readable form (for example, a personal computer). For example, the machine readable medium includes a read-only memory (ROM), a random access memory (RAM), a disk storage medium, an optical storage medium, a flash storage medium, electricity, light, sound and other forms of propagation signals (for example, a carrier, an infrared signal, a digital signal and the like), and the like.

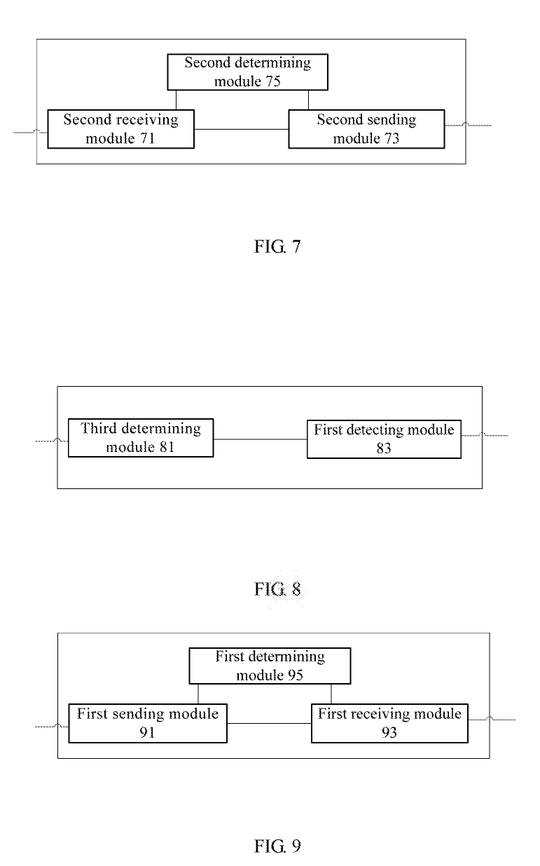

Referring to FIG. 7, a schematic structural diagram illustrating a second mobile terminal for audio and video communication according to some embodiments the present disclosure. The second mobile terminal according to this embodiment of the present disclosure includes a second receiving module 71, a second sending module 73 and a second determining module 75.

The second receiving module 71 is configured to receive a call request message sent by a first mobile terminal, wherein the call request message is used for requesting to establish audio and video communication between the first mobile terminal and the second mobile terminal.

The second sending module 73 is configured to reply to the call request message, and send a response message to the call request message to the first mobile terminal.

The second determining module 75 is configured to be communicably connected to a smart television, and determine to conduct the audio and video communication via the smart television such that the audio and video communication is conducted between the first mobile terminal and the smart television.

In the technical solution of the second mobile terminal for audio and video communication according to the embodiment of the present disclosure, when the audio and video communication is conducted, the second mobile terminal, as the called party, to which the smart television is connected may be prompted to determine whether to select the smart television to conduct the audio and video communication, and when the second determining module 75 determines to conduct the audio and video communication via the smart television, the audio and video communication is conducted between the second determining module 75 and the first mobile terminal. In this case, the audio and video information sent by the calling party, may be displayed on the smart television. In the technical solution according to the embodiment of the present disclosure, the large screen of the television and high definition thereof are fully utilized for the audio and video calls, and the image is clear. Since the old are familiar with operations of the television, the technical solution according to the embodiment of the present disclosure is suitable for the old at home, and the operations are convenient and simple.

Further, in the technical solution according to the embodiment of the present disclosure, that the second determining module 75 is communicably connected to the smart television specifically includes: establishing a communication connection between the second determining module 75 and the smart television via WiFi, USB or Bluetooth.

Further, in the technical solution according to the embodiments of the present disclosure, that the second determining module 75 determines to conduct the audio and video communication via the smart television, such that the audio and video communication is conducted between the first mobile terminal and the smart television includes: the second determining module 75 displays prompt information indicating whether to conduct the audio and video communication via the smart television, and when it is determined to conduct the audio and video communication via the smart television, the second determining module determines to conduct the audio and video communication via the smart television.

Referring to FIG. 8, a schematic structural diagram illustrating a smart television for audio and video communication according to some embodiments the present disclosure. The smart television for audio and video communication according to this embodiment of the present disclosure includes a third determining module 81 and a first detecting module 83.

The third determining module 81 is configured to communicably connect the smart television to a second mobile terminal.

The first detecting module 83 is configured to detect that the second mobile terminal receives a call request message, wherein the call request message is sent by a first mobile terminal and used for requesting to establish audio and video communication between the first mobile terminal and the second mobile terminal:

The first detecting module 83 detects that the second mobile terminal determines to conduct the audio and video communication with the first mobile terminal via the smart television.

When the first detecting module 83 detects that the second mobile terminal sends a response message to the call request message to the first mobile terminal, the audio and video communication is conducted between the third determining module 81 and the first mobile terminal.

In the technical solution of the smart television for audio and video communication according to the embodiment of the present disclosure, during the audio and video communication, when the first detecting module 83 detects that the second mobile terminal determines to conduct the audio and video communication with the first mobile terminal via the smart television, the audio and video communication is conducted between the smart television and the first mobile terminal. In this case, the audio and video information sent by the calling party, i.e., the first mobile terminal may all be displayed on the smart television, and the image is clear. In the technical solution according to the embodiment of the present disclosure, the large screen of the television and high definition thereof are fully utilized for the audio and video calls, and since the old are familiar with operations of the television, the technical solution according to the embodiment of the present disclosure is suitable for the old at home, and the operations are convenient and simple.

Further, in the technical solution according to the embodiment of the present disclosure, that the second mobile terminal is communicably connected to the smart television specifically includes: establishing a communication connection between the second mobile terminal and the smart television via WiFi, USB or Bluetooth.

Further, before the first detecting module 81 detects that the second mobile terminal determines to conduct the audio and video communication with the first mobile terminal via the smart television, the third determining module 83 is further configured to display prompt information indicating whether to conduct the audio and video communication via the smart television, and when it is determined to conduct the audio and video communication via the smart television, the second mobile terminal determines to conduct the audio and video communication via the smart television.

Referring to FIG. 9, a schematic structural diagram illustrating a first mobile terminal for audio and video communication according to some embodiments the present disclosure. The first mobile terminal according to this embodiment of the present disclosure includes a first sending module 91, a first receiving module 93 and a first determining module 95.

The first sending module 91 is configured to send a call request message to a second mobile terminal, wherein the call request message is used for requesting to establish audio and video communication between the first mobile terminal and the second mobile terminal.

The first receiving module 93 is configured to receive a response message to the call request message sent by the second mobile terminal.

The first determining module 95 is configured to be communicably connected to a smart television, and determine to conduct the audio and video communication via the smart television such that the audio and video communication is conducted between the second mobile terminal and the smart television.

In the technical solution of the first mobile terminal for audio and video communication according to the embodiment of the present disclosure, during the audio and video communication, when the first determining module 95 determines to conduct the audio and video communication via the smart television, the audio and video communication is conducted between the smart television and the second mobile terminal. In this case, the audio and video information sent by the called party, i.e., the second mobile terminal, may all be displayed on the smart television. In the technical solution according to the embodiment of the present disclosure, the large screen of the television and high definition thereof are fully utilized for the audio and video calls, and the image is clear. Since the old are familiar with operations of the television, the technical solution according to the embodiment of the present disclosure is suitable for the old at home, and the operations are convenient and simple.

Further, in the technical solution according to the embodiment of the present disclosure, that the first determining module 95 is communicably connected to the smart television specifically includes: establishing a communication connection between the second determining module 95 and the smart television via WiFi, USB or Bluetooth.

Further, in the technical solution according to the embodiments of the present disclosure, that the first determining module 95 determines to conduct the audio and video communication via the smart television, such that the audio and video communication is conducted between the second mobile terminal and the smart television includes: the first determining module 95 displays prompt information indicating whether to conduct the audio and video communication via the smart television, and when it is determined to conduct the audio and video communication via the smart television, the first determining module 95 determines to conduct the audio and video communication via the smart television.

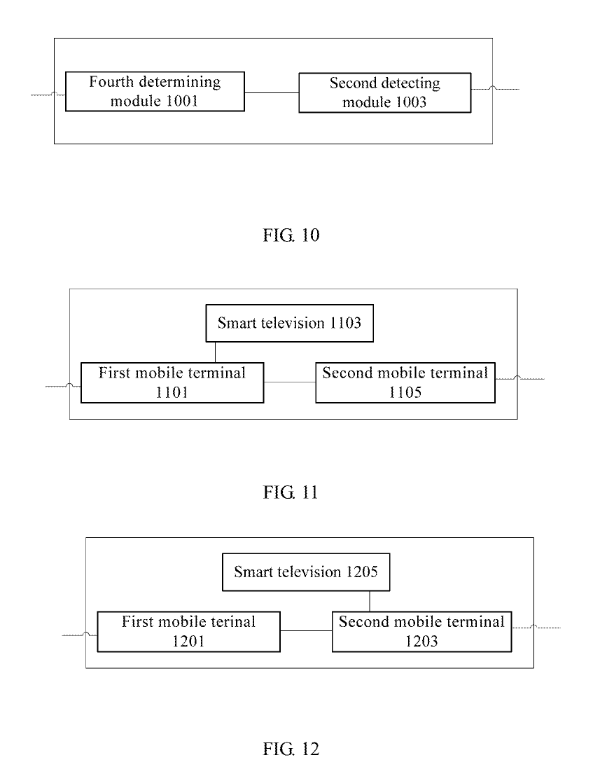

Referring to FIG. 10, a schematic structural diagram illustrating a smart television for audio and video communication according to some embodiments the present disclosure. The smart television for audio and video communication according to this embodiment of the present disclosure includes a fourth determining module 1001 and a second detecting module 1003.

The fourth determining module 1001 is configured to communicably connect the smart television to a first mobile terminal.

The second detecting module 1003 is configured to detect a call request message sent by the first mobile terminal, wherein the call request message is used for requesting to establish audio and video communication between the first mobile terminal and the second mobile terminal.

The second detecting module 1003 detects that the first mobile terminal determines to conduct the audio and video communication with the second mobile terminal via the smart television.

When the second detecting module 1003 detects that the second mobile terminal sends a response message to the call request message to the first mobile terminal, the audio and video communication is conducted between the fourth determining module 1001 and the second mobile terminal.

In the technical solution of the smart television for audio and video communication according to the embodiment of the present disclosure, during the audio and video communication, when the second detecting module 1003 detects that the first mobile terminal determines to conduct the audio and video communication with the second mobile terminal via the smart television, the audio and video communication is conducted between the smart television and the second mobile terminal. In this case, the audio and video information sent by the called party, i.e., the second mobile terminal may all be displayed on the smart television, and the image is clear. In the technical solution according to the embodiment of the present disclosure, the large screen of the television and high definition thereof are fully utilized for the audio and video calls, and since the old are familiar with operations of the television, the technical solution according to the embodiment of the present disclosure is suitable for the old at home, and the operations are convenient and simple.

Further, in the technical solution according to the embodiment of the present disclosure, that the second mobile terminal is communicably connected to the smart television specifically includes: establishing a communication connection between the second mobile terminal and the smart television via WiFi, USB or Bluetooth.

Further, in the technical solution according to the embodiment of the present disclosure, before the second detecting module 1003 detects that the second mobile terminal determines to conduct the audio and video communication with the first mobile terminal via the smart television, the fourth determining module 1001 is further configured to display prompt information indicating whether to conduct the audio and video communication via the smart television, and when it is determined to conduct the audio and video communication via the smart television, the second mobile terminal determines to conduct the audio and video communication via the smart television.

Referring to FIG. 11, a schematic structural diagram illustrating a system for smart television communication according to some embodiments of the present disclosure is illustrated. The system for smart television audio and video communication according to this embodiment of the present disclosure includes a first mobile terminal 1101, a smart television 1103 communicably connected to the first mobile terminal, and a second mobile terminal 1105.

The first mobile terminal 1101 sends a call request message to the second mobile terminal 1105 for requesting to establish audio and video communication between the first mobile terminal and the second mobile terminal, wherein the first mobile terminal 1101 is communicably connected to the smart television 1103.

The first mobile terminal 1101 determines to conduct the audio and video communication via the smart television 1103.

The second mobile terminal 1105 sends a response message to the call request message to the first mobile terminal 1101.

The audio and video communication is conducted between the smart television 1103 and the second mobile terminal 1105.

In the technical solution of the method for audio and video communication according to the embodiment of the present disclosure, when the audio and video communication is conducted, the first mobile terminal 1101, as the calling party, to which the smart television 1103 is connected may be prompted to determine whether to select the smart television 1103 to conduct the audio and video communication, and when the first mobile terminal 1101 determines to conduct the audio and video communication via the smart television 1103, the audio and video communication is conducted between the smart television 1103 and the second mobile terminal 1105. In this case, the audio and video information sent by the called party, i.e., the second mobile terminal 1105, may be displayed on the smart television 1103. In the technical solution according to the embodiment of the present disclosure, the large screen of the television and high definition thereof are fully utilized for the audio and video calls, and the image is clear. Since the old are familiar with operations of the television, the technical solution according to the embodiment of the present disclosure is suitable for the old at home, and the operations are convenient and simple.

Referring to FIG. 12, a schematic flowchart illustrating a system for smart television communication according to some embodiments of the present disclosure is illustrated. The system for smart television audio and video communication according to this embodiment of the present disclosure includes a first mobile terminal 1201, a second mobile terminal 1203, and a smart television 1205 communicably connected to the second mobile terminal.

The first mobile terminal 1201 sends a call request message to the second mobile terminal 1203 for requesting to establish audio and video communication between the first mobile terminal 1201 and the second mobile terminal 1203, wherein the second mobile terminal 1203 is communicably connected to the smart television 1205.

The second mobile terminal 1203 determines to conduct the audio and video communication via the smart television 1205.

The second mobile terminal 1203 sends a response message to the call request message to the first mobile terminal 1201.

The audio and video communication is conducted between the smart television 1205 and the first mobile terminal 1201.

In the technical solution of the method for audio and video communication according to the embodiment of the present disclosure, when the audio and video communication is conducted, the second mobile terminal 1203, as the called party, to which the smart television is connected may be prompted to determine whether to select the smart television 1205 to conduct the audio and video communication, and when the second mobile terminal 1203 determines to conduct the audio and video communication via the smart television 1205, the audio and video communication is conducted between the smart television 1205 and the first mobile terminal 1201. In this case, the audio and video information of the calling party may displayed on the smart television, and the image is clear. In the technical solution according to the embodiment of the present disclosure, the large screen of the television and high definition thereof are fully utilized for the audio and video calls, and since the old are familiar with operations of the television, the technical solution according to the embodiment of the present disclosure is suitable for the old at home, and the operations are convenient and simple.

In the technical solutions according to various embodiments of the present disclosure, some conventional smart televisions may fail to collect audio signals, and in this case, these conventional smart televisions need to be improved, that is, adding a microphone (not illustrated in the drawings) to the conventional smart televisions to collect the audio signals of the calling party or the called party, and in addition, a transmitting module (not illustrated in the drawings) is added in the conventional smart televisions, wherein the transmitting module is configured to transmit the collected audio signals. In addition, in the technical solutions according to various embodiments of the present disclosure, when the conventional smart television is equipped with a camera, that is, when the conventional smart television is capable of collecting video signals, the video signals are collected by using the smart television; when some smart televisions are not equipped with a camera and fails to collect video signals, these conventional smart televisions need to be improved, and a video collection element (for example, a camera) may be added to the conventional smart televisions, wherein the added video collection element collect video information.

Nevertheless, the technical solutions of audio and video communication according to various embodiments of the present disclosure are not merely limited to audio and video calls between two parties, and are also applicable to audio and video calls between three parties or more than three parties. The specific implementation process of the audio and video calls between three parties or more than three parties may refer to the implementation solutions of the audio and video calls between two parties according to various embodiments of the present disclosure, which are thus not described herein any further.

With respect to the methods for smart television audio and video communication according to the embodiments of the present disclosure, a hardware-based processor may be used to implement related functions. Execution of the methods for smart television audio and video communication according to the embodiments of the present disclosure by the hardware process may cover all the technical solutions according to various embodiments of the present disclosure, which is thus not described herein any further.

What is claimed is:

1. A method for smart television audio and video communication, applied to a smart television, the method comprising:
receiving, by a second mobile terminal, a call request message sent by a first mobile terminal for requesting to establish audio and video communication between the first mobile terminal and the second mobile terminal, wherein the second mobile terminal is communicably connected to the smart television;
determining, by the second mobile terminal, to conduct the audio and video communication via the smart television; and
replying, by the second mobile terminal, to the call request message, such that the audio and video communication is conducted between the first mobile terminal and the smart television.

2. The method according to claim 1, wherein that the second mobile terminal is communicably connected to the smart television specifically comprises:
establishing a communication connection between the second mobile terminal and the smart television via WiFi, USB or Bluetooth.

3. The method according to claim 1, wherein the replying, by the second mobile terminal, to the call request message, such that the audio and video communication is conducted between the first mobile terminal and the smart television comprises:
replying, by the second mobile terminal, to the call request message, such that communication is established between the first mobile terminal and the smart television, video information of the first mobile terminal is displayed on the smart television and audio signals of the first mobile terminal are played on the smart television, and audio signals of the second mobile terminal are transmitted to the first mobile terminal via the second mobile terminal.

4. The method according to claim 1, wherein the replying, by the second mobile terminal, to the call request message, such that the audio and video communication is conducted between the first mobile terminal and the smart television comprises:
replying, by the second mobile terminal, to the call request message, such that communication is established between the first mobile terminal and the smart television, video information of the first mobile terminal is displayed on the smart television and audio signals of the first mobile terminal are played on the smart television, and audio signals of the second mobile terminal are transmitted to the first mobile terminal via the smart television.

5. The method according to claim 1, wherein the determining, by the second mobile terminal, to conduct the audio and video communication via the smart television comprises:
displaying, by the second mobile terminal, prompt information indicating whether the audio and video communication is conducted via the smart television; and when the prompt information indicates that the audio and video communication is conducted via the smart television, determining, by the second mobile terminal, to conduct the audio and video communication via the smart television.

6. A method for smart television audio and video communication, applied to a smart television, the method comprising:
establishing a communication connection between the smart television and a second mobile terminal;
detecting, by the smart television, that the second mobile terminal receives a call request message, wherein the call request message is sent by a first mobile terminal and used for requesting to establish audio and video communication between the first mobile terminal and the second mobile terminal;
detecting, by the smart television, that the second mobile terminal determines to conduct the audio and video communication with the first mobile terminal via the smart television;
detecting, by the smart television, that the second mobile terminal sends a response message to the call request message, wherein the response message is sent by the second mobile terminal to the first mobile terminal; and
conducting, by the smart television, the audio and video communication with the first mobile terminal.

7. The method according to claim 6, wherein that the smart television is communicably connected to the second mobile terminal specifically comprises:
establishing a communication connection between the smart television and the second mobile terminal via WiFi, USB or Bluetooth.

8. The method according to claim 6, wherein the conducting, by the smart television, the audio and video communication with the first mobile terminal comprises:
displaying video information of the first mobile terminal on the smart television and playing audio signals of the first mobile terminal on the smart television, and transmitting audio signals of the second mobile terminal to the first mobile terminal via the second mobile terminal.

9. The method according to claim 6, wherein the conducting, by the smart television, the audio and video communication with the second mobile terminal comprises:
displaying video information of the first mobile terminal on the smart television and playing audio signals of the first mobile terminal on the smart television, and transmitting audio signals of the second mobile terminal to the first mobile terminal via the smart television.

10. The method according to claim 6, wherein the detecting, by the smart television, that the second mobile terminal determines to conduct the audio and video communication with the first mobile terminal via the smart television comprises:
displaying, by the smart television, prompt information indicating whether the audio and video communication is conducted via the smart television, and when the prompt information indicates that the audio and video communication is conducted via the smart television, determining, by the second mobile terminal, to conduct the audio and video communication via the smart television.

11. A method for smart television audio and video communication, applied to a smart television, the method comprising:
sending, by a first mobile terminal, a call request message to a second mobile terminal for requesting to establish audio and video communication between the first mobile terminal and the second mobile terminal, wherein the first mobile terminal is communicably connected to the smart television;
determining, by the first mobile terminal, to conduct the audio and video communication via the smart television; and
receiving, by the first mobile terminal, a response message to the call request message sent by the second mobile terminal, such that the audio and video communication is conducted between the smart television and the second mobile terminal.

12. The method according to claim 11, wherein
that the second mobile terminal is communicatively connected to the smart television specifically comprises: establishing a communication connection between the second mobile terminal and the smart television via WiFi, USB or Bluetooth.

13. The method according to claim 11, wherein the receiving, by the first mobile terminal, a response message to the call request message sent by the second mobile terminal, such that the audio and video communication is conducted between the smart television and the second mobile terminal comprises:
receiving, by the first mobile terminal, a response message to the call request message sent by the second mobile terminal, such that communication is established between the smart television and the second mobile terminal, video information of the second mobile terminal is displayed on the smart television and audio signals of the second mobile terminal are played on the smart television, and audio signals of the first mobile terminal are transmitted to the second mobile terminal via the first mobile terminal.

14. The method according to claim 11, wherein the receiving, by the first mobile terminal, a response message to the call request message sent by the second mobile terminal, such that the audio and video communication is conducted between the smart television and the second mobile terminal comprises:
receiving, by the first mobile terminal, a response message to the call request message sent by the second mobile terminal, such that communication is established between the smart television and the second mobile terminal, video information of the second mobile terminal is displayed on the smart television and audio signals of the second mobile terminal are played on the smart television, and audio signals of the first mobile terminal are transmitted to the second mobile terminal via the smart television.

15. The method according to claim 11, wherein the determining, by the first mobile terminal, to conduct the audio and video communication via the smart television comprises:
displaying, by the first mobile terminal, whether to display prompt information of the audio and video communication via the smart television; and when it is determined to display the prompt information via the smart television, determining, by the first mobile terminal, to conduct the audio and video communication via the smart television.

16. A method for smart television audio and video communication, applied to a smart television, the method comprising:
establishing a communication connection between the smart television and a first mobile terminal;
detecting, by the smart television, that the first mobile terminal sends a call request message, wherein the call request message is used for requesting to establish audio and video communication between the first mobile terminal and the second mobile terminal;
detecting, by the smart television, that the first mobile terminal determines to conduct the audio and video communication with the second mobile terminal via the smart television;
detecting, by the smart television, that the first mobile terminal receives a response message to the call request message, wherein the response message is sent by the second mobile terminal; and
conducting, by the smart television, the audio and video communication with the second mobile terminal.

17. The method according to claim 16, wherein that the smart television is communicably connected to the first mobile terminal specifically comprises:
establishing a communication connection between the smart television and the first mobile terminal via WiFi, USB or Bluetooth.

18. The method according to claim 16, wherein the conducting, by the smart television, the audio and video communication with the second mobile terminal comprises:
displaying video information of the second mobile terminal on the smart television and playing audio signals of the second mobile terminal on the smart television, and transmitting audio signals of the first mobile terminal to the second mobile terminal via the first mobile terminal.

19. The method according to claim 16, wherein the conducting, by the smart television, the audio and video communication with the second mobile terminal comprises:
displaying video information of the second mobile terminal on the smart television and playing audio signals of the second mobile terminal on the smart television, and transmitting audio signals of the first mobile terminal to the second mobile terminal via the smart television.

20. The method according to claim 16, wherein the detecting, by the smart television, that the first mobile terminal determines to conduct the audio and video communication with the second mobile terminal via the smart television comprises:
displaying, by the smart television, prompt information indicating whether the audio and video communication is conducted via the smart television, and when the prompt information indicates that the audio and video communication is conducted via the smart television, determining, by the first mobile terminal, to conduct the audio and video communication via the smart television.
